(19) United States
(12) Patent Application Publication
(10) Pub. No.: US 2015/0167795 A1
(43) Pub. Date: Jun. 18, 2015

(54) TWIN PLANET ACTIVE DRIVE CONTINUOUSLY VARIABLE TRANSMISSION

(71) Applicant: Minoru NAKAGAWA, Yokohama-city (JP)

(72) Inventor: Minoru NAKAGAWA, Yokohama-city (JP)

(21) Appl. No.: 14/632,883

(22) Filed: Feb. 26, 2015

Related U.S. Application Data
(63) Continuation of application No. PCT/JP2013/071445, filed on Aug. 1, 2013.
Application No. PCT/JP2013/071445 is a continuation of application No. 14/404,382, filed on Nov. 26, 2014.

(30) Foreign Application Priority Data
Jun. 3, 2012 (JP) 2012-138212
Aug. 28, 2012 (JP) 2012-202058

(51) Int. Cl. F16H 3/76

(52) U.S. Cl. CPC F16H 3/76

(57) ABSTRACT

It is possible to allow the output which is inputted from a “Planetary gear self-actuating control continuous variable mechanism” of the prior application, JP2012-138212, to always ensure one-to-one input to the output to attain a high continuously variable output by coupling drives with the documented configuration. An output that is one-to-one to the input of a sun gear (4) via a set of a ring gear (2) of a planetary gear and a support frame (1) can be ensured, and a high gear ratio, in the form of multiplying the output, and a continuously varied output of the active sun gear (4) can be freely done using a configuration in which the one set of a ring gear (2) of a planetary gear, a support frame (1) is coupling drove with a parent-child planetary gear (8) that promotes a rotation and revolution control drive on a single central shaft, which is described in the prior application JP2012-138212, “Planetary gear self-actuating control continuous variable mechanism,” and with the continuous variable speed drive from the output that is one-to-one to the input from the support frame of application JP2012-138212.

### TECHNICAL FIELD

The present invention relates to a continuously variable transmission mechanism among the power transmissions of a planetary gear.

### BACKGROUND ART

The rotation transmission system practically used according to the planetary gear arrangement is practically used by a stepwise shift transmission method by the lock-up wherein each gear ratio is fixed.

The rotation transmission system practically used according to the planetary gear arrangement is an arrangement wherein each gear ratio is fixed, and therefore, it has been practically insufficient to obtain a continuously variable transmission.

However, although as shown in FIG. 2, the “planetary gear self-actuated control drive type continuously variable transmission mechanism” which have been filed as Japanese Patent Application 2012-138212 making it possible to carry out a continuously variable transmission according to the planetary gear arrangement wherein a gear ratio is fixed, makes it possible to realize a rotation and revolution control drive means according to freely parents planetary gears, but there is a limit to the size of the parent-child planetary gear diameter, and the combination of each gears etc., and there is a disadvantage that it is impossible to obtain a high gear ratio.

Even if an output in the above prior application mechanism is a driving arrangement via a new planetary gear, there is a problem that it is impossible to ensure an output on one-on-one level with input because the output on one-on-one level with input is multiplied with a speed up gear wherein the gear ration is fixed.

### PRIOR ART LITERATURE

### Patent Literature

JP 2012-138212

### Non Patent Literature

### DISCLOSURE OF THE INVENTION

### Problems to be Resolved by the Invention

The problem to be solved is that a driving arrangement wherein an output in the above prior application mechanism is carried out via a new planetary gear, is characterized by an output on one-on-one level with input being multiplied with a speed up drive wherein the gear ration is fixed, and therefore, it is impossible to obtain a further continuously variable transmission output from a form to ensure an output on one-on-one level with input in the above prior application mechanism.

### Means of Solving the Problems

In order to obtain a high transmission ratio which ensures an output on one-on-one level with input, the present invention is most mainly characterized in that it comprises:

a set of planetary gear at the secondary side with a single central shaft, and

wherein a drive is attained by the use of a support frame (1) of the planetary gear and a ring gear (2), and the parents planetary gears which are capable of carrying out a rotation and revolution control drive freely and realized with the above prior application mechanism to carry out a connecting drive of a secondary side of planetary gear by the continuously variable transmission output of the above prior application mechanism of itself and to carry out the twin continuously variable transmission drive by multiplying the continuously variable transmission output of the above prior application mechanism with the planetary gear at secondary side.

### EFFECT OF INVENTION

The twin planet active drive continuously variable transmission according to the present invention is characterized in that it is capable of attaining a drive of the planetary gear at secondary side by the continuously variable transmission output of the above prior application mechanism of itself to ensure an output on one-on-one level with input in the above prior application mechanism which is impossible on before, and to carry out the twin continuously variable transmission drive by multiplying the continuously variable transmission output of the above prior application mechanism with the planetary gear at secondary side, and therefore, it has an advantage that it is used as a continuously variable transmission wherein it is possible to carry out a drive of a freely and active continuously variable transmission by itself and it is compact and having a high ration of transmission without a complicated control device etc.

### BRIEF DESCRIPTION OF THE DRAWINGS

FIG. 1 gives a cross-sectional view showing an arrangement and an implementation methods for twin planet active drive continuously variable transmission (partially shown). (Example 1)

FIG. 2 is a diagram showing a “planetary gear self-actuated control drive type continuously variable transmission mechanism” which have been filed as Japanese Patent Application No.: 2012-138212.

### MODE FOR CARRYING OUT THE INVENTION

Although it has been impossible to realize an output of a continuously variable transmission by one planetary gear configuration, in order to attain an object to provide a continuously variable transmission wherein the securement of an output on one-on-one level with input by multiplying the continuously variable transmission output makes it possible to give a drive of a freely and active continuously variable transmission and a high change gear ratio, it is possible to carry out a continuously variable transmission by connecting a planetary gear of the above prior application mechanism with a planetary gear at secondary side with a single central shaft to obtain a twin drive.

### Example 1

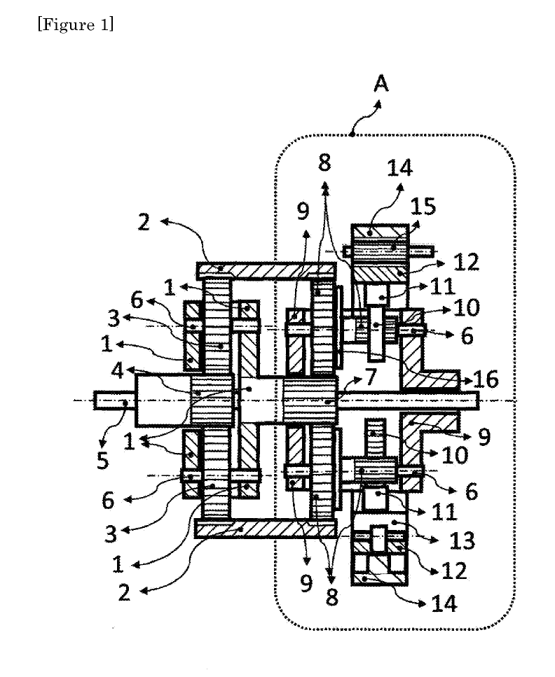

FIG. 1 gives a cross-sectional view showing an example of a twin planet active drive continuously variable transmission (partially shown for convenience), and 1 is a support frame integrated with a sun gear 7, 2 is a ring gear, 3 is a planet gear, 4 is a sun gear of the output side, 5 is a single central shaft and 6 is a shaft.

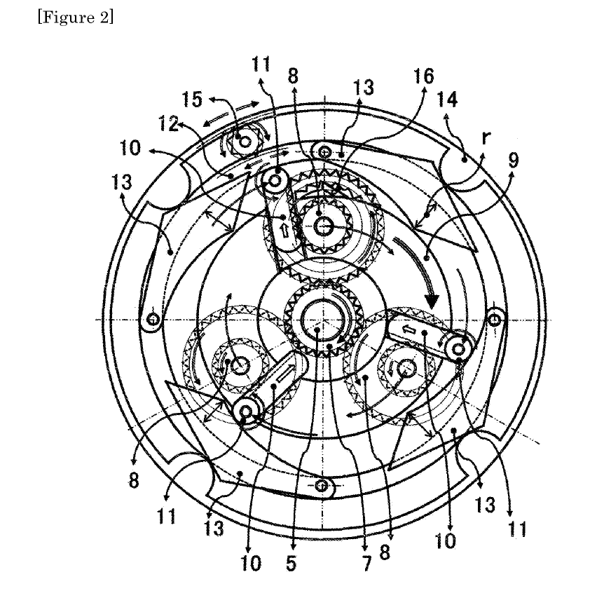

The reference numerals of each member which surround with a dotted line A of FIG. 1 is the same as those of the above prior application mechanism (Example 1) of FIG. 2, it is shown that 7 is a sun gear, 8 is a parent-child planetary gear with one-way mechanism, 9 is a support frame of the input side, 10 is a push gear, 11 is a power roller. 12 is an outer circumferential support frame, 13 is a cam arm, 14 is an outer cam, 15 is a control gear, 16 is a one-way mechanism by a parent-child planetary gear and r is an amount of lift.

A support frame (1) for supporting a planetary gear (3) is attached and integrated with a sun gear of the above prior application mechanism, and the sun gear (7) integrated with the support frame (1) and a ring gear (2) is meshed with a large gear of the parent-child planetary gear (8) of the above prior application mechanism, a planetary gear (3) is meshed with a ring gear (2) and a sun gear (4) of the output side.

A driving force to a sun gear (4) via each member meshed by an input of a support frame (9) of the above prior application mechanism makes is possible to rotate the parent-child planetary gear (8) integrated with a support frame (9) of the input side via each member meshed by a load of the sun gear (4) to mesh the parent-child planetary gear (8) with a push gear (10) with a power roller and thereby allowing the power roller to continue to push an internal surface of an outer circumferential support frame (12) to make a rotation. And the rotation makes it possible to attain a stop of the reciprocating motion of the push gear (10) to obtain a revolution drive on one-on-one level with input by stopping the rotation of the meshed parent-child planetary gear (8) forcibly.

A drive on one-on-one level with input of the support frame (1) integrated with a sun gear (7) meshed with a parent-child planetary gear (8), and a drive on one-on- one level with input of a ring gear (2) meshed with a parent-child planetary gear (8), and these drive make it possible to stop forcibly the rotation of the planetary gear (3) of the support frame (1) meshed with a ring gear (2) to attain a drive on one-on-one level with input, and thereby driving a sun gear (4) meshed with a planetary gear forcibly to ensure output on one-on-one level with input to obtain a stable low geared.

In a similar way, by the rotary drive of the control gear (15) via the outer cam (14), the cam arm (13) is pushed from the surface of the inner wall of the outer circumferential support frame (12), an input of a support frame (9) of the above prior application mechanism makes it possible to push back the push gear, every time the parent-child planetary gear (8) integrated and rotated with the support frame (9) and the power roller (11) of the push gear (10) which pushes the surface of the inner wall of the outer circumferential support frame (12), pass through the cam arm (13), the reciprocating drive of the push gear (10) is carried out through the one-way mechanism (16), and an addition of the forcible driving force of the rotation to the opposite direction of the input for the revolution driving parent-child planetary gear (8) sequentially makes it possible to carry out a faster drive for the direction of input of the support frame (1) integrated with the meshed sun gear (7) than a drive speed on one-on-one level with input.

A ring gear (2) meshed with the drive, the decelerating drive to a region of stopping the input direction drive in a form of backing away from a speed of a drive on one-to-one level with input make it possible to add a rotation drive to an opposite direction for input in addition to a revolution drive on one-to-one level with input of the planetary gear (3) of a support frame (1) meshed with the ring gear (2). And a form that a meshed sun gear (4) at a secondary output side allows the output rotation of the sun gear of the above prior application mechanism to multiply, makes it possible to attain a drive to an input direction continuously to obtain a high geared region.

It has effects that a self-operated control drive capable of promoting a rotation and revolution freely and directly according to a parent-child planetary gear (8) via an input of a support frame (9) of the prior application mechanism makes it possible to drive a secondary side of a planetary gear to obtain a drive from ensuring an output that is one-to-one to the input using a secondary side of an output sun gear to a high geared region having an active continuously variable transmission and a high gear ratio, by a configuration of the twin continuously variable transmission drive of the single central shaft (5) in a lump.

FIG. 2 is a member shown in a dotted line A of FIG. 1, that is, a “planetary gear self-actuated control drive type continuously variable transmission mechanism” which have been filed as Japanese Patent Application No.: 2012-138212, and each the reference numerals etc., is shown and changed in accordance with the reference numerals used in the present invention.

According to a configuration that the members such as an outer circumferential support frame (12), a cam arm (13), an outer cam (14), a control gear (15) provided with outside of the push gear (10), are supported by a power roller (11) provided with a side of the push gear, makes it possible to produce a configuration for attaining a reduced diameter of a member such as an outer circumferential support frame (12) etc., provided with a side of the support frame (9) of the input, a gear ratio of each gear, a size, a shape, and a position of each member, a member for supporting these member, or one-way mechanism (including other), and an installation of a bearing or a return spring etc., may be changed according to each application.

### INDUSTRIAL APPLICABILITY

It is possible to apply it as a new another application comparing with two shaft type of CVT having a relatively large range of a shift transmission, since it is a small continuously variable transmission making it possible to change freely a drive from ensuring an output that is one-to-one to the input using a configuration in which two planetary gear are coupling drove with on a single central shaft to a high geared region having a high gear ratio by an active continuously variable transmission.

### DESCRIPTION OF THE REFERENCE NUMERALS

1 a support frame integrated with a sun gear
2 a ring gear with an internal gear from side to side
3 a planetary gear
4 a sun gear of the output side
5 a single central shaft
6 a shaft
7 a sun gear
8 a parent-child planetary gear with one-way mechanism
9 a support frame of the input side
10 a push gear
11 a power roller
12 an outer circumferential support frame
13 a cam arm
14 an outer cam
15 a control gear
16 a one-way mechanism by a parent-child planetary gear
r an amount of lift

1. A twin planet active drive continuously variable transmission, wherein a set of a ring gear (2) of a planetary gear and a support frame (1) is coupled and drove with a parent-child planetary gear (8) that promotes a rotation and revolution control drive on a single central shaft, which is described in the prior application JP2012-138212, “Planetary gear self-actuating control continuous variable mechanism,”, and
the continuous variable speed drive from the output that is one-to-one to the input from the support frame of application JP2012-138212 allows to ensure an output on one-to-one level with the input of a sun gear (4) via the set of a ring gear (2) of a planetary gear and a support frame (1), and to freely obtain a high gear ratio in the form of multiplying the output and to carry out a continuously varied output change of the active sun gear (4).
